(19) United States
(12) Patent Application Publication
(10) Pub. No.: US 2005/0147036 A1
(43) Pub. Date: Jul. 7, 2005

(54) Method and apparatus for enabling an adaptive replay loop in a processor

(75) Inventors: Per H. Hammarlund, Hillsboro, OR (US); Stephan J. Jourdan, Portland, OR (US)

Correspondence Address: KENYON & KENYON, Suite 600, 333 W. San Carlos Street, San Jose, CA, 95110-2711, US

(73) Assignee: Intel Corporation

(21) Appl. No.: 10/749,271

(22) Filed: Dec. 30, 2003

(51) Int. Cl. H04L 1/00

(52) U.S. Cl. 370/230; 370/235; 370/412

(57) ABSTRACT

A method and apparatus for enabling an adaptive replay loop in a processor. More particularly, the present invention relates to allowing instructions in the replay loop to change its relative position, thereby decreasing the latency for execution of instructions, resolving dynamic resource conflicts, and also increasing the overall efficiency of the processor.

### BACKGROUND OF THE INVENTION

The primary function of most computer processors is to execute computer instructions. Most processors execute instructions in the programmed order that they are received. However, some recent processors, such as the Pentium®. II processor from Intel Corp., are “out-of-order” processors. An out-of-order processor can execute instructions in any order as the data and execution units required for each instruction becomes available. Therefore, with an out-of-order processor, execution units within the processor that otherwise may be idle can be more efficiently utilized.

With either type of processor, delays can occur when executing “dependent” instructions. A dependent instruction, in order to execute correctly, requires a value produced by another instruction that has executed correctly. For example, consider the following set of instructions:
1) Load memory-1 into register-X;
2) Add1 register-X register-Y into register-Z;
3) Add2 register-Y register-Z into register-W.

The first instruction loads the content of memory-1 into register-X. The second instruction adds the content of register-X to the content of register-Y and stores the result in register-Z. The third instruction adds the content of register-Y to the content of register-Z and stores the result in register-W. In this set of instructions, instructions 2 and 3 are dependent instructions that are dependent on instruction 1 (instruction 3 is also dependent on instruction 2). In other words, if register-X is not loaded with the proper value in instruction 1 before instructions 2 and 3 are executed, instructions 2 and 3 will likely generate incorrect results. Dependent instructions can cause a delay in known processors because most known processors typically do not schedule a dependent instruction until they know that the instruction that the dependent instruction depends on will produce the correct result.

Referring now to the drawings, FIG. 1 is a block diagram of a processor pipeline and timing diagram illustrating the delay caused by dependent instructions in most known processors. In FIG. 1, a scheduler 105 schedules instructions. The instructions proceed through an execution unit pipeline that includes pipeline stages 110, 115, 120, 125, 130, 135 and 140. During each pipeline stage a processing step is executed. For example, at pipeline stage 110 the instruction is dispatched. At stage 115 the instruction is decoded and source registers are read. At stage 120 a memory address is generated (for a memory instruction) or an arithmetic logic unit (“ALU”) operation is executed (for an arithmetic or logic instruction). At stage 125 cache data is read and a lookup of the translation lookaside buffer (“TLB”) is performed. At stage 130 the cache Tag is read. At stage 135 a hit/miss signal is generated as a result of the Tag read. The hit/miss signal indicates whether the desired data was found in the cache (i.e., whether the data read from the cache at stage 125 was the correct data). As shown in FIG. 1, the hit/miss signal is typically generated after the data is read at stage 125, because generating the hit/miss signal requires the additional steps of TLB lookup and Tag read.

The timing diagram of FIG. 1 illustrates the pipeline flow of two instructions: a memory load instruction (“Ld”) and an add instruction (“Add”). The memory load instruction is a six-cycle instruction, the add instruction is a one-cycle instruction, and the add instruction is dependent on the load instruction. At time=0 (i.e., the first clock cycle) Ld is scheduled and dispatched (pipeline stage 110). At time=1, time=2 and time=3, Ld moves to pipeline stages 115, 120 and 258, respectively. At time=4, Ld is at pipeline stage 130. At time=5, Ld is at stage 135 and the hit/miss signal is generated. Scheduler 105 receives this signal. Finally at time=6, assuming a hit signal is received indicating that the data was correct, scheduler 105 schedules Add to stage 110, while Ld continues to stage 140, which is an additional pipeline stage. The add operation is eventually performed when Add is at stage 120. However, if at time=6 a miss signal is received, scheduler 105 will wait an indefinite number of clock cycles until data is received by accessing the next levels of the cache hierarchy.

As shown in the timing diagram of FIG. 1, Add, because it is dependent on Ld, cannot be scheduled until time=6, at the earliest. A latency of an instruction may be defined as the time from when its input operands must be ready for it to execute until its result is ready to be used by another instruction. Therefore, the latency of Ld in the example of FIG. 1 is six. Further, as shown in FIG. 1, scheduler 105 cannot schedule Add until it receives the hit/miss signal. Therefore, even if the time required to read data from a cache, potentially shorter than the time to compute the correct hit/miss signal, decreases with improved cache technology, the latency of Ld will remain at six because it is dependent on the hit/miss signal.

Reducing the latencies of instructions in a processor is sometimes necessary to increase the operating speed of a processor. For example, suppose that a part of a program contains a sequence of N instructions, I₁, I₂, I₃ . . . I_{N}. Suppose that Iₙ₊₁ requires, as part of its inputs, the result of Iₙ, for all n, from 1 to N-1. This part of the program may also contain any other instructions. The program cannot be executed in less time than T=L₁+L₂+L₃+ . . . +L_{N}, where Lₙ is the latency of instruction Iₙ, for all n from 1 to N. In fact, even if the processor was capable of executing a very large number of instructions in parallel, T remains a lower bound for the time to execute this part of this program. Hence to execute this program faster, it will ultimately be essential to shorten the latencies of the instructions.

Based on the foregoing, there is a need for a computer processor that can schedule instructions, especially dependent instructions, faster than known processors, and therefore reduces the latencies of the instructions.

### BRIEF DESCRIPTION OF THE DRAWINGS

FIG. 1 is a block diagram of a prior art processor pipeline and timing diagram illustrating the delay caused by dependent instructions in most known processors.

FIG. 2 is a block diagram of a processor pipeline and timing diagram in accordance with one embodiment of the present invention.

FIG. 3 is a block diagram of a processor in accordance with one embodiment of the present invention.

FIG. 4 is a block diagram of an adaptive replay system in accordance with one embodiment of the present invention.

FIGS. 5a & 5b is a block diagram illustrating the operation of an adaptive replay system in accordance with one embodiment of the present invention.

FIGS. 6a, 6b & 6c is a block diagram illustrating the operation of an adaptive replay system in accordance with one embodiment of the present invention.

FIGS. 7a, 7b & 7c is a block diagram illustrating the operation of an adaptive replay system in accordance with one embodiment of the present invention.

FIGS. 8a, 8b & 8c is a block diagram illustrating the operation of an adaptive replay system in accordance with one embodiment of the present invention.

FIG. 9 is a flow diagram of the operation of an adaptive replay system in accordance with one embodiment of the present invention.

### DETAILED DESCRIPTION OF THE DRAWINGS

One embodiment of the present invention is a processor that speculatively schedules instructions and that includes a replay system. The replay system replays instructions that were not executed correctly when they were initially dispatched to an execution unit. Further, the replay system preserves the originally scheduled order of the instructions.

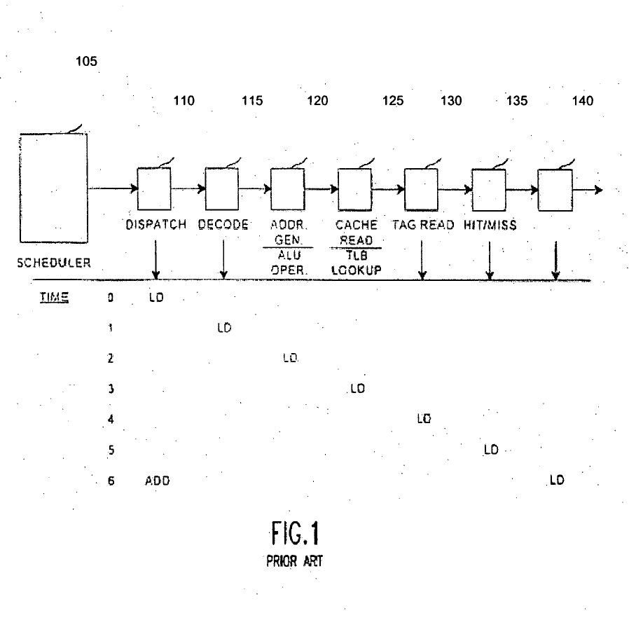

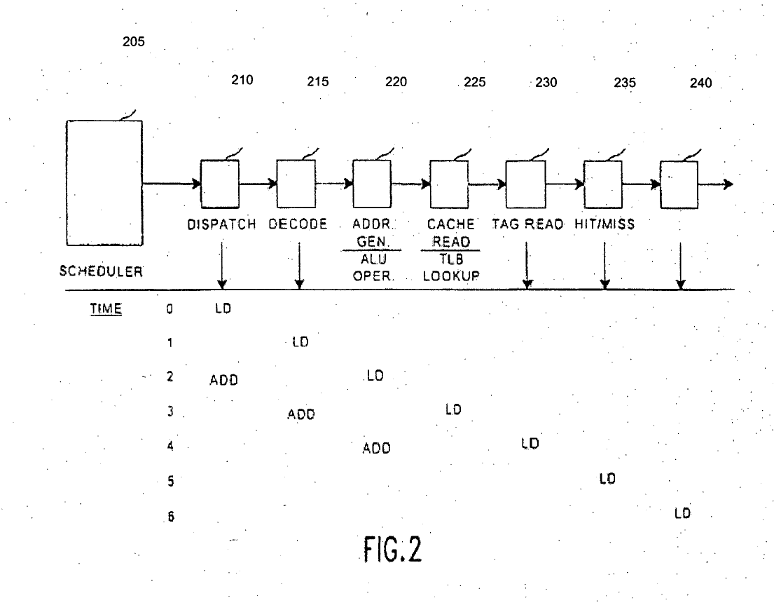

FIG. 2 is a block diagram of a processor pipeline and timing diagram in accordance with one embodiment of the present invention. In FIG. 2, a scheduler 205 schedules instructions to pipeline stages 210, 215, 220, 225, 230, 235 and 240, which are identical in function to the stages shown in FIG. 1. The timing diagram of FIG. 2 illustrates a two-cycle Ld followed by a one-cycle Add. Scheduler 205 speculatively schedules Add without waiting for a hit/miss signal from Ld. Therefore, Add is scheduled at time=2, so that a two stage distance from Ld is maintained because Ld is a two-cycle instruction. Add is eventually executed at time=4 when it arrives at stage 220, which is one cycle after Ld performs the cache read at stage 225.

By speculatively scheduling Add, scheduler 205 assumes that Ld will execute correctly (i.e., the correct data will be read from the cache at stage 18). A comparison of FIG. 2 with FIG. 1 illustrates the advantages of speculatively scheduling Add. Specifically, in FIG. 1, the Add instruction was not scheduled until time=6, thus Ld had a latency of six. In contrast, in FIG. 2 the Add instruction was scheduled at time=2, thus Ld had a latency of only two, or four less than the Ld in FIG. 1. Further, scheduler 205 in FIG. 2 has slots available to schedule additional instructions at time=3 through time=6, while scheduler 10 in FIG. 1 was able to only schedule one add instruction by time=6. Therefore, the present invention, by speculatively scheduling, reduces the latency of instructions and is able to schedule and process more instructions than the prior art.

However, this embodiment of the present invention must account for the situation when an instruction is speculatively scheduled assuming that it will be executed correctly, but eventually is not executed correctly (e.g., in the event of a cache miss). The present invention resolves this problem by having a replay system. The replay system may replay all instructions that executed incorrectly.

The replay system or loop is an efficient way to allow the instructions to be executed again. As is known in the art, the instructions remain fixed at the same relative position to the instructions they depend on as created by the scheduler when replayed in the replay loop. However, in this embodiment of the present invention, when the instructions are replayed in the adaptive replay system, the instructions are allowed to change position in the replay loop, decreasing the latency for execution of instructions and also increasing the overall efficiency of the processor.

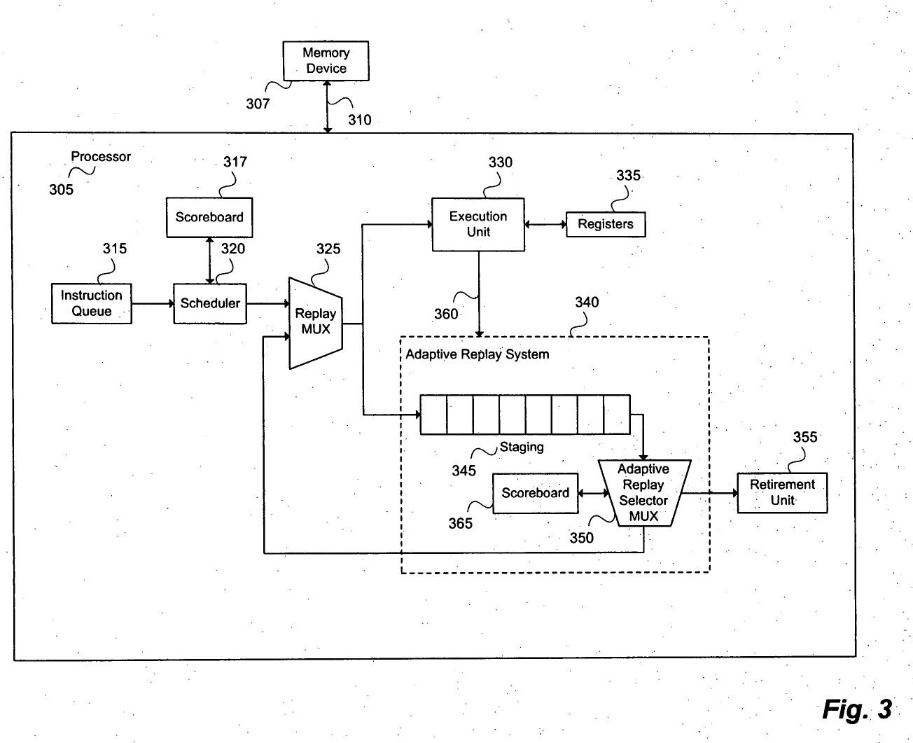

FIG. 3 is a block diagram of a processor system in accordance with one embodiment of the present invention. In this embodiment, the processor 305 is included in a computer system (not shown). Processor 305 may be coupled to other components of the computer, such as a memory device 307 through a system bus 310.

Processor 305 includes an instruction queue 315. Instruction queue 315 feeds instructions into scheduler 320. In one embodiment, the instructions are “micro-operations.” (also known as “Uops”). Micro-operations are generated by translating complex instructions into simple, fixed length instructions for ease of execution.

Scheduler 320 dispatches an instruction received from instruction queue 315 when the resources are available to execute the instruction and when sources needed by the instruction are indicated to be ready. Scheduler 320 is coupled to a scoreboard 317. Scoreboard 317 indicates the readiness of each source (i.e., each register) in processor 305.

In one embodiment, scoreboard 317 allocates one bit for each register, and if the bit is a “1” the register is indicated to be ready. Scoreboard 317 reflects the ready state of registers based on correct execution of the Uops, allowing speculation. Other embodiments of the present invention can be implemented without a scoreboard, by utilizing a valid bit that flows along with the data. Scheduler 320 schedules instructions based on the scoreboard's status of the registers. For example, a “Ld X into Reg-3” instruction (i.e., load the value in memory location “X” to register 3) is followed by an “Add Reg-3 into Reg-4” instruction (i.e., add the value in register-3 to the value in register-4 and store it in register-4). The Add instruction is dependent on the Ld instruction because. Reg-3 must be ready before the Add instruction is executed. Scheduler 320 will first schedule the Ld instruction, which is a two-cycle instruction. Scheduler 320 will then check scoreboard 317 on each cycle to determine if Reg-3 is ready. Scoreboard 317 will not indicate that Reg-3 is ready until the second cycle, because Ld is a two-cycle instruction. On the second cycle, scheduler 320 checks scoreboard 317 again, sees the indication that Reg-3 is now ready, and schedules the Add instruction on that cycle. Therefore, through the use of scoreboard 317, scheduler 320 is able to schedule instructions in the correct order with proper spacing based on the Uop latencies.

Scheduler 320 speculatively schedules instructions because the instructions are scheduled when a source is indicated to be ready by scoreboard 317. However, scheduler 320 does not determine whether a source is in fact ready before scheduling an instruction needing the source. For example, a load instruction may be a two-cycle instruction. This may mean that the correct data is loaded into a register in two cycles (not counting the dispatch and decode stage) if the correct data is found in a first level of memory (e.g., a first level cache hit). Scoreboard 317 indicates that the source is ready after two cycles. However, if the correct data was not found in the first level of memory (e.g., a first level cache miss), the source is actually not ready after two cycles. However, based on scoreboard 317, scheduler 320 will speculatively schedule the instruction anyway.

Scheduler 320 outputs the instructions to a replay multiplexer (“MUX”) 325. The output of multiplexer 325 is coupled to an execution unit 330. Execution unit 330 executes received instructions. Execution unit 330 can be an arithmetic logic unit (“ALU”), a floating point ALU, a memory unit, etc. Execution unit 330 is coupled to registers 335 which are the registers of processor 305. Execution unit 330 loads and stores data in registers 335 when executing instructions.

Processor 305 further includes an adaptive replay system 340. Adaptive replay system 340 replays instructions that were not executed correctly after they were scheduled by scheduler 320. Adaptive replay system 340, like execution unit 330, receives instructions output from replay multiplexer 325. Adaptive replay system 340 includes a staging section 345. Staging section 345 includes a plurality of stages. Therefore, instructions are staged through adaptive replay system 340 in parallel to being staged through execution unit 330. The number of stages varies depending on the amount of staging desired in each execution channel.

Adaptive replay system 340 includes an adaptive replay selector multiplexer 350. Adaptive replay MUX 350 is adapted to receive instructions from staging 345 and determines whether each instruction has executed correctly. If the instruction has executed correctly, adaptive replay MUX 350 declares the instruction “replay safe” and the instruction is forwarded to a retirement unit 355 where it is retired. Retiring instructions is beneficial to processor 305 because it frees up processor resources and allows additional instructions to start execution. If the instruction has not executed correctly, adaptive replay MUX 350 replays or re-executes the instruction by sending the instruction to replay multiplexer 325.

An instruction may execute incorrectly for many reasons. The most common reasons are a source dependency or an external replay condition. A source dependency can occur when an instruction source is dependent on the result of another instruction. Examples of an external replay condition include a cache miss, incorrect forwarding of data (e.g., from a store buffer to a load), hidden memory dependencies, a write back conflict, an unknown data/address, and serializing instructions.

Adaptive replay selector MUX 350 may determine that an instruction should be replayed based on an external signal (replay signal 360). Execution unit 330 sends replay signal 360 to adaptive replay MUX 350. Replay signal 360 indicates whether an instruction has executed correctly or not. Replay signal 360 is staged so that it arrives at adaptive replay MUX 350 at the same point that the instruction in question arrives at adaptive replay MUX 350. For example, if the instruction in question is a Ld, replay signal 360 is a hit/miss signal. The Ld instruction is staged in adaptive replay system 340 so that it arrives at adaptive replay MUX 350 at the same time that the hit/miss signal for that Ld instruction is generated by execution unit 330. Therefore, adaptive replay MUX 350 can determine whether to replay the Ld instruction based on the received hit/miss signal.

In one embodiment of the invention, adaptive replay selector MUX 350 is coupled to a scoreboard 365 which, like scoreboard 317, indicates which registers have valid data. Using scoreboard 365 adaptive replay MUX 350 can determine that an instruction has not executed correctly because the data in the required register is not valid. For example, if a Ld instruction was a miss, and the next instruction received by adaptive replay MUX 350 is an Add instruction that is dependent on the Ld instruction, adaptive replay MUX 350, by using scoreboard 365, will determine that the Add instruction did not execute correctly because the data in the register needed by the Add instruction is not valid.

In one embodiment, processor 305 is a multi-channel processor. Each channel includes all of the components shown in FIG. 3. However, the execution unit 330 for each channel will differ. For example, execution unit 330 for one channel will be a memory unit, execution unit 330 for another channel will be an arithmetic unit, etc. Each channel includes its own adaptive replay system 340.

In one embodiment, processor 305 is a multi-threaded processor. In this embodiment, adaptive replay MUX 350 causes some of the threads to be retired while others are replayed. Therefore, adaptive replay MUX 350 allows execution unit 305 to be more efficiently used by many threads.

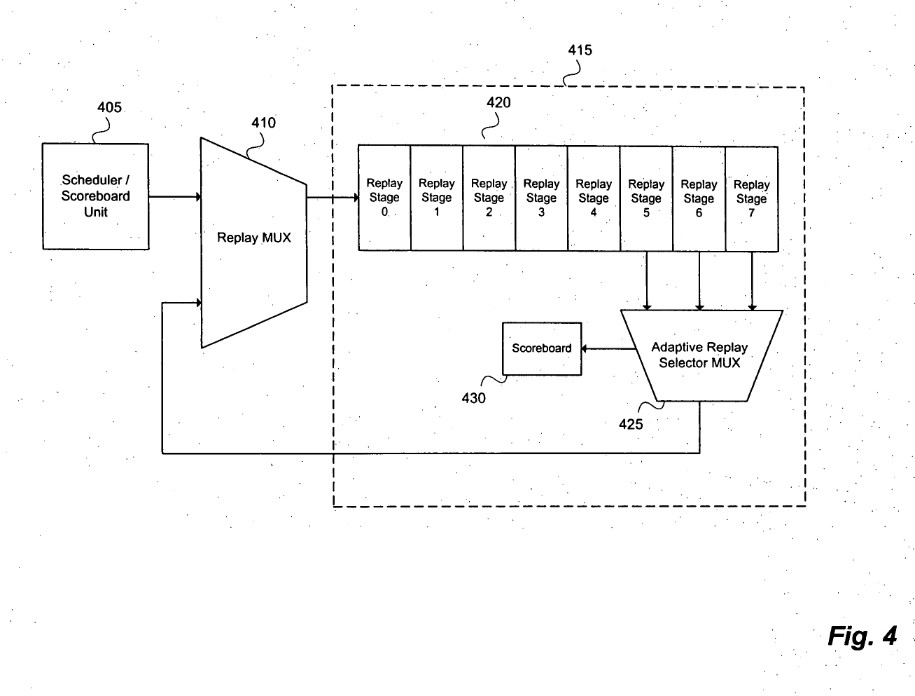

FIG. 4 is a block diagram of an adaptive replay system in accordance with one embodiment of the present invention. The scheduler scoreboard unit 405 is coupled to replay MUX 410. The scheduler scoreboard unit 405 receives an instruction from instruction queue (not shown). When the resources are available for execution and when sources needed by the instruction are ready, scheduler scoreboard unit 405 dispatches the instructions to a replay MUX 410. Instructions from replay MUX 410 are output to execution units (not shown) and adaptive replay system 415. The instructions are staged through adaptive replay system 415 in parallel to being staged through the execution units. In this embodiment of the invention, replay stages 420 include replay stage 0 through replay stage 7. However, the number of stages may vary depending on the number of stages in each execution channel (e.g. an ALU, a floating point unit, a memory unit, etc.)

Adaptive replay system 415 includes an adaptive replay selector multiplexer 425. Adaptive replay MUX 425 analyzes multiple instructions within replay stages 420. In this embodiment of the invention, adaptive replay MUX 425 includes three inputs from replay stages 420. Therefore, adaptive replay MUX 425 looks at three instructions at one time. The adaptive replay selector MUX 425 allows instructions to change position in the replay loop enabling greater overall processor efficiency.

In one embodiment of the invention, adaptive replay selector MUX 425 is coupled to a scoreboard 430 which stores information for each instruction. Scoreboard 430 keeps information on the latency of each instruction and the distance to the closest instruction that it depends on, and, the resource conflicts that the instruction may have encountered during the last execution. The information relating to the latency and distance to the closest instruction it depends on is first determined during scheduling and is updated every time the instruction is executed. Also, whenever an instruction encounters a resource conflict during execution, the scoreboard is updated with the information.

When an instruction needs to be replayed, adaptive replay selector MUX 425 can utilize the information stored in scoreboard 430 to check if the instruction is at the optimal position in the replay loop. Based on the information, adaptive replay MUX 425 can change the instruction's relative position in the replay loop (e.g. a Uop that is scheduled late as compared to the Uop it depends on is allowed to move ahead within replay stages 420 closer to the Uop it depends on). For an instruction that has a resource conflict, adaptive replay MUX 425 can utilize the information in scoreboard 430 to check if the conflicting instruction is replaying, arid if so, will allow one of the instructions to change position to avoid or minimize the chance of a resource conflict.

In one embodiment, the adaptive replay system 415 allows instructions to move more than two positions in the replay loop. As such, an instruction that needs to be moved to an optimal position can be moved around a perfectly scheduled instruction in the replay loop, i.e. an instruction that will not be moved. Furthermore, an instruction may be moved across multiple perfectly scheduled instructions when necessary.

In one embodiment, the adaptive replay selector MUX 425 may change the position of an instruction that needs to be replayed either forward or backward relative to its current position in the replay loop. Adaptive replay MUX 425 can analyze whether moving an instruction backward (which increases the latency of the execution of the instruction) will increase overall execution efficiency before carrying out the move (e.g., moving an instruction backward and increasing the latency may be the best overall remedy to resolve resource conflicts).

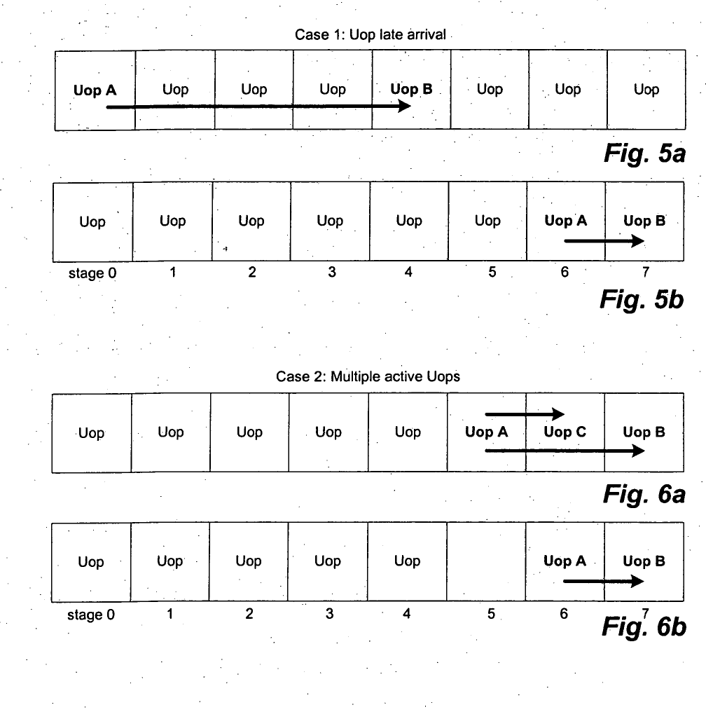

FIGS. 5a & 5b are block diagrams illustrating the operation of an adaptive replay system in accordance with one embodiment of the present invention. In FIGS. 5a & 5b, an example of the operation of the adaptive replay system given the late arrival of a Uop is shown. In FIG. 5a, Uop A is dependent on Uop B. Uop A arrives in the scheduler later than when it is ready and is scheduled immediately. Uop A is not in an optimal position behind the instruction that it depends directly upon, Uop B. An increased latency of a few clock cycles results if Uop A is not moved to an optimal position in relation to Uop B. In FIG. 5b, the adaptive replay selector MUX positions Uop A at a position that results in the smallest possible delay in relation to Uop B in order to increase execution efficiency.

FIGS. 6a & 6b are block diagrams illustrating the operation of an adaptive replay system in accordance with one embodiment of the present invention. In FIGS. 6a & 6b, an example of the operation of the adaptive replay system given multiple active Uops is shown. In FIG. 6a, Uop A is dependent on Uop C and Uop B; Uop B and C both have a 1 clock latency. When Uop C goes replay safe, Uop A is now only dependent on Uop B. Since Uop A is dependent on Uop B and is two clocks from Uop B, it can now be scheduled in an optimal position behind Uop B, the instruction it depends upon. An increased latency results if Uop A is not moved to an optimal position in relation to Uop B, ready for execution. In FIG. 6b, the adaptive replay selector MUX positions Uop A at a position that results in the smallest possible delay in relation to Uop B in order to increase execution efficiency.

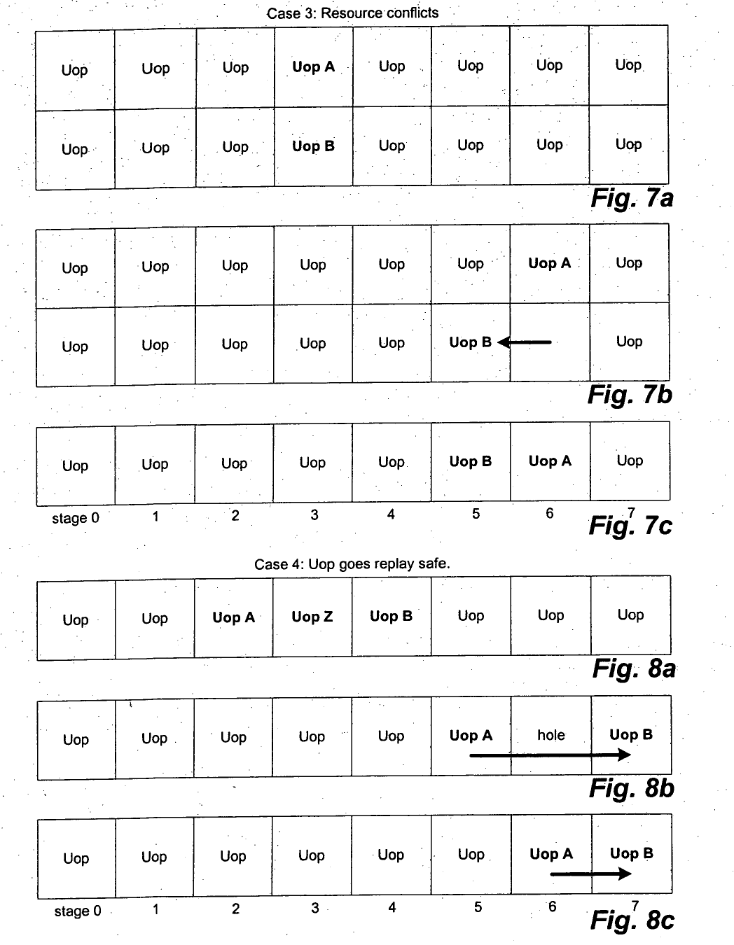

FIGS. 7a, 7b & 7c are block diagrams illustrating the operation of a two-channel adaptive replay system in accordance with one embodiment of the present invention. In FIGS. 7a, 7b & 7c, an example of the adaptive replay system given a resource conflict is shown. In FIG. 7a, Uop A and Uop B are scheduled at the same time. In this case, both Uop A and Uop B are scheduled correctly in relation to the Uop they depend on. However, both need the same execution resource, and access to the resource in the computer is not at a service rate that is the same as the Uop execution bandwidth (e.g. level-2 cache). In FIG. 7b, adaptive replay selector MUX determines that one of the Uops cannot complete in its current position. In FIG. 7c, adaptive replay MUX moves Uop B one position backward to solve the resource conflict.

FIGS. 8a, 8b & 8c are block diagram illustrating the operation of an adaptive replay system in accordance with one embodiment of the present invention. In FIGS. 8a, 8b & 8c, an example of the adaptive replay system given a Uop that goes “replay safe” is shown. In FIG. 8a, Uop B, Uop Z, and Uop A are staged in the adaptive replay system as shown. Uop A is dependent on Uop B. When a Uop goes replay safe, it leaves a hole in the replay loop. In FIG. 8b, Uop Z goes replay safe and an open position is left in the replay loop. In FIG. 8c, the adaptive replay selector MUX schedules Uop A to fill the hole, to position it to the closest position to Uop B in order to increase execution efficiency.

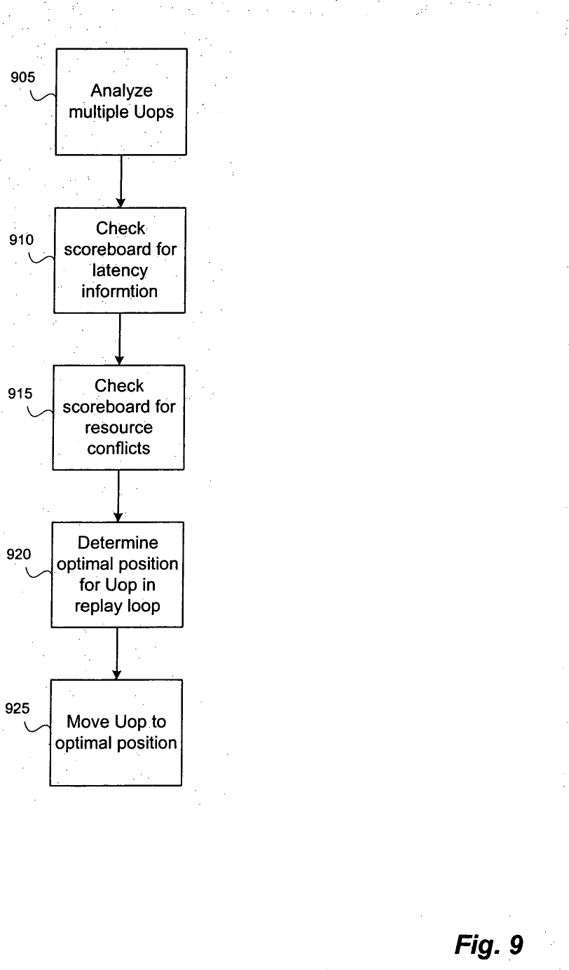

FIG. 9 is a flow diagram of the operation of an adaptive replay system in accordance with one embodiment of the present invention. FIG. 9 illustrates the operation of the adaptive replay selector MUX according to one embodiment of the present invention. In block 905, the adaptive replay MUX 425 analyzes multiple Uops in the staging area 420 of the adaptive replay system 415. Control is forwarded to block 910, where adaptive replay MUX 425 checks scoreboard 435 for latency information for each of the multiple Uops being analyzed. In block 915, adaptive replay MUX then checks scoreboard 435 for possible resource conflicts for each of the multiple Uops being analyzed. Control passes to block 920, and adaptive replay MUX 425 utilizes the information stored in scoreboard 435 to determine the optimal position in the replay loop for each Uop being analyzed. In block 925, adaptive replay MUX 425 moves each Uop being analyzed to its optimal position, to a position that is the smallest possible in relation to the Uop which it depends while avoiding resource conflicts. Thereby, adaptive replay system 415 increases the overall efficiency of the processor by decreasing latency and increasing execution efficiency.

In another embodiment of the invention, a multi-channel replay system can be implemented. The adaptive replay system can be configured to move Uops not only within the same channel (i.e. the scheduler port), but between compatible channels. For example, if there are two ALU channels, and two independent Uops are scheduled in only one channel, a multi-channel adaptive replay system can chose to move one Uop to the unused channel.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive the scope of the invention being indicated by the appended claims, rather than the foregoing description, and all changes that come within the meaning and range of equivalency of the claims are therefore intended to be embraced therein.

1. An adaptive replay system comprising:
a staging unit to forward an instruction in a replay loop parallel to an execution unit;
a selector device coupled to said staging area to place said instruction in an optimal position within said replay loop; and
a scoreboard coupled to said selector device to store status information for said instruction.

2. The system of claim 1 wherein said staging unit is comprised of multiple stages.

3. The system of claim 1 wherein said status information is latency, dependency and resource conflict information.

4. The system of claim 2 wherein said multiple stages are equivalent in number to a number of stages in said execution unit.

5. The system of claim 2 wherein said adaptive replay system is implemented within a multiple channel processor.

6. The system of claim 5 wherein said selector device is to place said instruction in said optimal position within said replay loop, from a first channel to a second channel, based on status information for said instruction stored in said scoreboard.

7. The system of claim 1 wherein said selector device is to analyze at least one instruction per clock cycle to determine whether said at least one instruction has executed correctly.

8. The system of claim 7 wherein said selector device analyzes 3 instructions per clock cycle.

9. The system of claim 1 wherein said selector device places said instruction in said optimal position within said replay loop based on status information for said instruction stored in said scoreboard.

10. The system of claim 9 wherein said selector device can move instructions at least one position relative to a current position to said optimal position in said replay loop.

11. The system of claim 3 wherein said-scoreboard stores latency and dependency information for said instruction when said instruction is first scheduled, and updates latency and dependency information for said instruction when said instruction is executed.

12. The system of claim 3 wherein said scoreboard stores resource conflicts for said instruction when said instruction encounters a resource conflict during execution.

13. A computer processing system comprising:
a multiplexer having a first input, a second input, and an output;
a scheduler coupled to said multiplexer first input;
an execution unit coupled to said multiplexer output;
a memory device coupled to said execution unit; and
a replay system having an output coupled to said second multiplexer input;
wherein said replay system includes:
a staging unit coupled to said multiplexer output to forward an instruction in a replay loop parallel to an execution unit; and
a selector device coupled to said staging unit, said selector multiplexer is adapted to place an instruction to an optimal position within said replay loop; and
a scoreboard coupled to said selector device to store status information for said instruction.

14. The system of claim 13 wherein said staging unit is comprised of multiple stages.

15. The system of claim 13 wherein said status information is latency, dependency and resource conflict information.

16. The system of claim 14 wherein said replay system is implemented within a multiple channel processor.

17. The system of claim 16 wherein said selector device is to place said instruction in said optimal position within said replay loop, from a first channel to a second channel, based on status information for said instruction stored in said scoreboard.

18. The system of claim 13 wherein said selector device is to analyze at least one instruction per clock cycle to determine whether said at least one instruction has executed correctly.

19. The system of claim 13 wherein said selector device is to place said instruction in said optimal position within said replay loop based on status information for said instruction stored in said scoreboard.

20. The system of claim 19 wherein said selector device can move instructions at least one position relative to a current position to said optimal position in said replay loop.

21. The system of claim 15 wherein said scoreboard is to store latency and dependency information for said instruction when said instruction is first scheduled, and updates latency and dependency information for said instruction when said instruction is executed.

22. The system of claim 15 wherein said scoreboard stores resource conflicts for said instruction when said instruction encounters a resource conflict during execution.

23. A method of processing a computer instruction in a replay loop comprising:
analyzing multiple instructions from a staging unit;
checking a scoreboard for latency information for each of said multiple instructions;
checking said scoreboard for dependency information for each of said multiple instructions;
checking said scoreboard for resource conflicts for each of said multiple instructions;
determining an optimal position for each of said multiple instructions in said replay loop; and
moving each of said instructions to said optimal position in said replay loop.

24. The method of claim 23 wherein analyzing multiple instructions from a staging unit, a replay selector device analyzes 3 instructions per clock cycle.

25. The method of claim 23 wherein determining an optimal position for each of said multiple instructions in said replay loop is based on latency, dependency and resource conflict information for said instruction stored in said scoreboard.

26. The method of claim 23 wherein moving each of said instructions to said optimal position in said replay loop, a replay selector device can move instructions at least one position relative to a current position to said optimal position in said replay loop.

27. A set of instructions residing in a storage medium, said set of instructions capable of being executed by a processor to implement a method of processing a computer instruction in a replay loop comprising:
analyzing multiple instructions from a staging unit;
checking a scoreboard for latency information for each of said multiple instructions;
checking said scoreboard for dependency information for each of said multiple instructions;
checking said scoreboard for resource conflicts for each of said multiple instructions;
determining an optimal position for each of said multiple instructions in said replay loop; and
moving each of said instructions to said optimal position in said replay loop.

28. The set of instructions of claim 27 wherein analyzing multiple instructions from a staging unit, a replay selector device analyzes 3 instructions per clock cycle.

29. The set of instructions of claim 27 wherein determining an optimal position for each of said multiple instructions in said replay loop is based on latency, dependency and resource conflict information for said instruction stored in said scoreboard.

30. The set of instructions of claim 27 wherein moving each of said instructions to said optimal position in said replay loop, a replay selector device can move instructions at least one position relative to a current position to said optimal position in said replay loop.
